(19) United States
(12) Patent Application Publication
(10) Pub. No.: US 2026/0364760 A1
(43) Pub. Date: Nov. 19, 2026

(54) ELECTROMAGNETIC ACTUATION MECHANISM

(71) Applicant: Illinois Tool Works Inc., Glenview, IL (US)

(72) Inventor: Tommaso Passerin d'Entreves et Courmayeur, Portes-lès-Valence (FR)

(21) Appl. No.: 19/103,125

(22) PCT Filed: Aug. 8, 2023
(86) PCT No.: PCT/US2023/071842

§ 371 Date: Feb. 11, 2025

(30) Foreign Application Priority Data
Aug. 17, 2022 (EP) 22315184.6

(51) Int. Cl. B25C 1/06

(52) U.S. Cl. CPC B25C 1/06

(57) ABSTRACT

The present disclosure relates to a mechanism for applying a retraction force to a striking pin of a nailer, the mechanism comprising an elongate drive member with one or more permanent magnets; a striking pin connected to the elongate drive member; and an electromagnetic coil surrounding part of the elongate drive member; wherein the electromagnetic coil may be energized, in use, to apply a force to the elongate drive member to urge it toward a retracted position.

### PRIORITY CLAIM

This application is a national stage application of PCT/US2023/071842, filed on Aug. 8, 2023, which claims priority to and the benefit of European Patent Application No. 22315184.6, which was filed Aug. 17, 2022, the entire contents of each of which are incorporated herein by reference.

This present disclosure relates generally to electromagnetic actuation mechanisms. More specifically, although not exclusively, the present disclosure relates to an electromagnetic mechanism for retracting the striking pin of a nailer and/or retaining the striking pin in a predetermined position, such as a retracted or partially retracted position.

### BACKGROUND

Nailers typically include a drive member with a striking pin at one of its ends, which is driven pneumatically (such as by compressed air), electromagnetically, or by an explosive reaction, such as with an explosive charge or with flammable gases such as butane or propane.

Retraction of the drive member is normally achieved using a spring or some other biasing mechanism against which the driving actuator must operate. This reduces the performance of the driving actuator, as it must overcome the biasing force to drive the striking pin in use. It would therefore be beneficial to provide an actuation mechanism for retracting the striking pin, which does not affect the operation of the primary driving actuator.

### SUMMARY

A first aspect of the present disclosure provides a mechanism for applying a retraction force to a striking pin of a nailer, the mechanism comprising an elongate drive member with one or more permanent magnets, a striking pin connected to the elongate drive member and an electromagnetic coil surrounding part of the elongate drive member, wherein the electromagnetic coil may be energised, in use, to apply a force to the elongate drive member to urge it toward a retracted position.

The skilled person will appreciate that the provision of an electromagnetic coil that selectively applies a retraction force to the elongate drive member by virtue of its interaction with one or more permanent magnets avoids the aforementioned reduction in performance of the driving actuator, and enables the coil to be compact.

A more general aspect of the present disclosure provides an actuation mechanism, which may be used for actuating the striking pin of a nailer, the mechanism comprising an elongate drive member with one or more permanent magnets and an electromagnetic coil surrounding part of the elongate drive member, wherein the electromagnetic coil may be energised, in use, to move the elongate drive member between deployed and retracted positions.

Another aspect of the present disclosure provides a mechanism, e.g. for a nailer, the mechanism comprising an elongate drive member with two or more permanent magnets spaced along its length and an electromagnetic coil surrounding part of the elongate drive member, wherein the electromagnetic coil may be energised, in use, to move the elongate drive member.

The electromagnetic coil may be energised, in use, to move the elongate drive member from the or a deployed position to the or a retracted position. The mechanism may be operable to energise, in use, the electromagnetic coil to move the elongate drive member from the or a deployed position to the or a retracted position.

Additionally or alternatively, the electromagnetic coil may be energised, in use, to brake or dampen a striking movement of the striking pin. The mechanism may be operable to energise, in use, the electromagnetic coil to brake or dampen a striking movement of the striking pin. The striking movement may be from the retracted position to or toward the deployed position. The electromagnetic coil may be energised, in use, to brake or dampen a movement of the striking pin from the retracted position to or toward the deployed position. The electromagnetic coil may be energised, in use, to brake or dampen the movement or striking movement of the striking pin as it approaches the deployed position.

The elongate drive member may comprise a rod, for example to which the one or more permanent magnets may be mounted. The rod may be non-magnetic. The striking pin may be at or adjacent or mounted to the trailing end of the elongate drive member or rod. Alternatively, the striking pin may be at or adjacent or mounted to an intermediate portion or the leading end of the elongate drive member. The striking pin may be connected directly or indirectly to the elongate drive member or rod. The striking pin may, but need not, be parallel to the elongate drive member or rod.

The one or more permanent magnets may comprise two or more, e.g. a plurality of, permanent magnets. The magnets may be spaced along the length of the elongate drive member.

The strength of each successive magnet may increase, e.g. increase progressively, toward a trailing end of the elongate drive member. As used herein, the term ‘trailing end’ refers to the trailing end of the elongate drive member as it moves from the deployed position toward the retracted position. Similarly, the term ‘leading end’ refers to the leading end of the elongate drive member as it moves from the deployed position toward the retracted position. The spacing between adjacent magnets may increase, e.g. increase progressively, toward the trailing end.

The strength of the magnets and/or the spacing between the magnets may either or both be configured to provide a substantially constant electromagnetic retraction force to the elongate drive member, e.g. as it moves from a deployed position toward a retracted position.

The spacing between adjacent magnets may be at least partially dependent upon at least one of the strength of the magnets and a length of the coil, e.g. along a longitudinal axis of the elongate drive member.

The mechanism may comprise a control mechanism, which may be operable or configured to supply power to the electromagnetic coil.

In some examples, the control mechanism may be operable or configured to supply power to the electromagnetic coil substantially continuously. In such examples, varying the intensity of the magnets and/or the spacing between them may encourage or ensure that a retraction force is applied to the elongate drive member continuously or substantially continuously.

In some examples, the control mechanism may be operable or configured to supply pulses of power to the electromagnetic coil. In such examples, varying the intensity of the magnets and/or the spacing between them may not be necessary.

The strength of the magnets may be substantially the same. The spacing between the magnets may be substantially the same. Such an arrangement may be preferable where the control mechanism is operable or configured to supply pulses of power to the electromagnetic coil.

The mechanism may comprise an orientation sensor, such as a gyro sensor or gyroscope. The orientation sensor may be operatively connected to the control mechanism, e.g. for determining, in use, an orientation of a nailer in which the mechanism is incorporated. The control mechanism may be operable or configured to supply power, e.g. pulses of power, at least partially in dependence upon an orientation determined using the orientation sensor or data obtained therefrom.

The mechanism may comprise an initiator magnet. The initiator magnet may be at or toward a leading end of the elongate drive member, e.g. opposite the trailing end. The initiator magnet may have the opposite polarity to all other magnets. The initiator magnet may have a first polarity. At least one or all of the remaining magnets, e.g. of the plurality of magnets, may have a second polarity, which may be opposite the first polarity.

The mechanism may comprise a retention magnet. The retention magnet may be configured to retain the elongate drive member in a predetermined position, e.g. a retracted or partially retracted position. For this purpose, a separate magnet may be used, or one of the one or more magnets may be used.

Another aspect of the present disclosure provides a nailer comprising the aforementioned mechanism.

Another aspect of the present disclosure provides a method of applying a retraction force to a striking pin of a nailer.

The method may comprise a method of retracting a striking pin of a nailer. The method may comprise a method of braking or dampening the movement of the striking pin of a nailer.

Another aspect of the present disclosure provides a method of moving a striking pin of a nailer.

The method may comprise energising an electromagnetic coil to apply a force to an elongate drive member that includes one or more permanent magnets. The method may comprise applying the force to urge the elongate drive member, and/or a striking pin connected thereto, toward a retracted position toward a retracted position. The method may comprise moving the elongate drive member, and/or a striking pin connected thereto, between deployed and retracted position, e.g. from a deployed position toward a retracted position.

Another aspect of the present disclosure provides a method of braking or dampening the movement of the striking pin of a nailer.

The method may comprise energising an electromagnetic coil to brake or dampen a striking movement of the striking pin. The striking movement may be from a retracted position to or toward a deployed position. The method may comprise energising an electromagnetic coil to brake or dampen a movement of the striking pin from a retracted position to or toward a deployed position. The method may comprise energising an electromagnetic coil to brake or dampen the movement or striking movement of the striking pin as it approaches the deployed position.

For the avoidance of doubt, any of the features described herein apply equally to any aspect of the present disclosure.

For purposes of this disclosure, and notwithstanding the above, it is to be understood that any controller(s), control units and/or control modules described herein may each comprise a control unit or computational device having one or more electronic processors. The controller may comprise a single control unit or electronic controller or alternatively different functions of the control of the system or apparatus may be embodied in, or hosted in, different control units or controllers or control modules. As used herein, the terms “control mechanism”, “control unit” and “controller” will be understood to include both a single control unit or controller and a plurality of control units or controllers collectively operating to provide the required control functionality. A set of instructions could be provided which, when executed, cause said controller(s) or control unit(s) or control module(s) to implement the control techniques described herein (including the method(s) described herein). The set of instructions may be embedded in one or more electronic processors, or alternatively, may be provided as software to be executed by one or more electronic processor(s).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the present disclosure, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the present disclosure will now be described by way of example only with reference to the accompanying drawings in which:

FIG. 1 is schematic representation of a mechanism for retracting the striking pin of a nailer according to a first example;

FIG. 2 is schematic representation of a mechanism for retracting the striking pin of a nailer according to a second example;

FIG. 3 is schematic representation of a mechanism for retracting the striking pin of a nailer according to a third example; and

FIG. 4 is schematic representation of a mechanism for retracting the striking pin of a nailer according to a fourth example.

### DETAILED DESCRIPTION

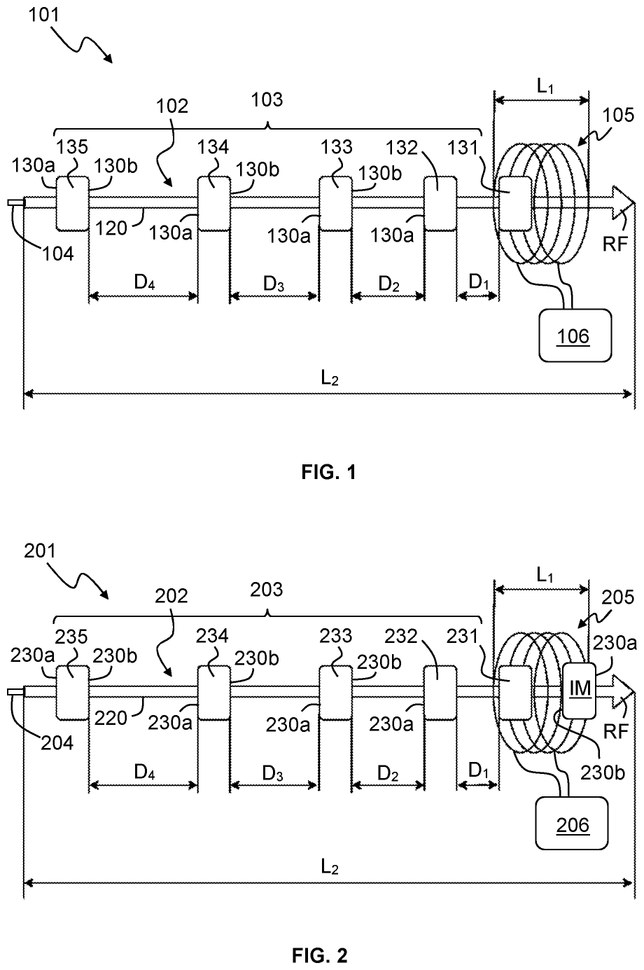

Referring now to FIG. 1, there is shown a retraction mechanism 101 for retracting the striking pin of a nailer. The mechanism 101 is shown in a deployed position and includes an elongate drive member 102 with a series of permanent magnets 103, a striking pin 104 connected to the elongate drive member 102 and an electromagnetic coil 105 surrounding part of the elongate drive member 102. In this example, the striking pin 104 is connected directly to the elongate drive member 102 at a first of its ends, for example a trailing end of the elongate drive member 102. However, the skilled person will appreciate that it could be connected directly or indirectly to any part of the elongate drive member 102, to enable its retraction. The retraction mechanism 101 may also include a control mechanism 106, but this is preferably incorporated within the circuitry of the nailer (not shown).

The elongate drive member 102 includes a non-magnetic rod 120 to which the series of magnets 103 is mounted. The series of magnets 103 include a first magnet 131, toward a leading end of the elongate drive member 102 and nearest the electromagnetic coil 105, with second, third, fourth and fifth magnets 132, 133, 134, 135 spaced successively along the length of the elongate drive member 102 toward its trailing end.

Each of the magnets 131, 132, 133, 134, 135 has a first pole 130a facing the trailing end of the elongate drive member 102 and a second pole 130b on its opposite side. The first pole 130a is on the same side of all of the magnets 131, 132, 133, 134, 135, such that they all have the same polarity.

In this example, the strength or intensity of each successive magnet 131, 132, 133, 134, 135 increases progressively from the leading end toward the trailing end. Specifically, the strength or intensity of the fifth magnet 135 is greater than that of the fourth magnet 134, which is greater than that of the third magnet 133, and so on.

In addition, the spacing D₁, D₂, D₃, D₄ between adjacent magnets 131, 132, 133, 134, 135 also increases progressively toward the trailing end. Specifically, the first and second magnets 131, 132 are spaced by a first distance D₁ and the second and third magnets 132, 133 are spaced by a second distance D₂, which is greater than the first distance D₁. Similarly, the third and fourth magnets 133, 134 are spaced by a third distance D₃, which is greater than the second distance D₂, and the fourth and fifth magnets 134, 135 are spaced by a fourth distance D₄, which is greater than the third distance D₃.

The electromagnetic coil 105 has a length L₁ along the longitudinal axis of the elongate drive member 102. The elongate drive member 102 also has a longitudinal length L₂. The magnets 131, 132, 133, 134, 135 are spread along the length L₂ of the elongate drive member 102.

The skilled person will appreciate that, whilst FIG. 1 depicts permanent magnets 131, 132, 133, 134, 135 having substantially the same length, the increased intensity may be achieved by placing a plurality of similar magnets 131, 132, 133, 134, 135 together in series. In such a case, the distances D₁, D₂, D₃, D₄ referred to above may be distances between the centre of such composite magnet structures.

In this example, the control mechanism 106 is configured to supply power to the electromagnetic coil 105 substantially continuously. As a result, the energised electromagnetic coil 105 generates an electromagnetic field that interacts with the first magnet 131 to impart a retraction force RF to move the elongate drive member 102 toward a retracted position.

As the elongate drive member 102 moves, the first magnet 131 approaches a neutral position within the electromagnetic coil 105, where the second magnet 132 then interacts with the electromagnetic coil 105. The increased strength or intensity of the second magnet 132 in relation to the first magnet 131 ensures that its interaction with the electromagnetic coil 105 maintains the retraction force RF on the elongate drive member 102. This will continue with the subsequent magnets 133, 134, 135 until the elongate drive member 102 reaches a fully retracted position.

The skilled person will also appreciate that the fifth magnet 135 may also function as a retention magnet, by keeping the electromagnetic coil 105 in the energised state after the elongate drive member 102 is fully retracted. Prior to firing the nailer (not shown), power may be removed from the electromagnetic coil 105 to avoid affecting the operation of the primary driving actuator (not shown).

The strength of the magnets 131, 132, 133, 134, 135, and the spacing between them, are configured to provide a substantially constant electromagnetic retraction force RF to the elongate drive member 102 in this example. These features are intrinsically linked, and are also dependent upon the power applied to the electromagnetic coil 105. More particularly, the skilled person will appreciate that the profile of the electromagnetic retraction force RF applied to the elongate drive member 102 during its movement will depend upon the spacing between adjacent magnets 131, 132, 133, 134, 135, their strength, the length L1 of the electromagnetic coil 105 and the power to be applied thereto.

Referring now to FIG. 2, there is shown a retraction mechanism 201 according to a second example, similar to the retraction mechanism 101 described above, wherein like features are depicted with like references incremented by ‘100’ and will not be described further herein.

The retraction mechanism 201 according to this example differs from the previous example in that it includes an initiator magnet 236 at a leading end of the elongate drive member 202, opposite the trailing end. The initiator magnet 236 is on the opposite side of the electromagnetic coil 205 to the other magnets 231, 232, 233, 234, 235, and its polarity is reversed.

As such, when the electromagnetic coil 205 is energised by the controller 206, a repulsive force is applied to the initiator magnet IM. The skilled person will appreciate that this improves substantially the initial acceleration of the elongate drive member 202.

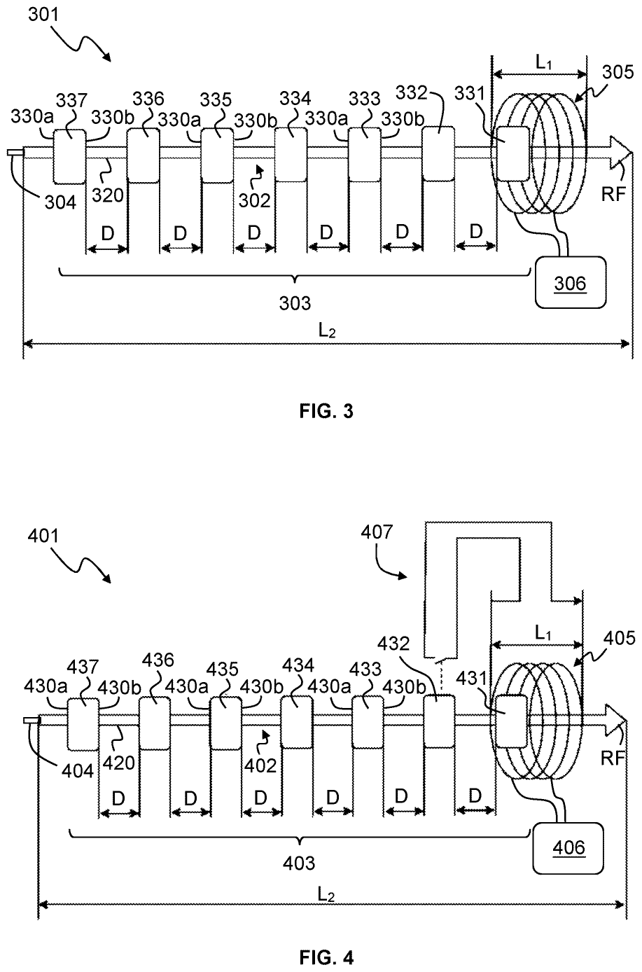

Referring now to FIG. 3, there is shown a retraction mechanism 301 according to a third example, similar to the retraction mechanism 101 according to the first example described above. Like features are depicted with like references incremented by ‘200’ and will not be described further herein.

The retraction mechanism 301 according to this example differs from the first example in that there are seven magnets 331, 332, 333, 334, 335, 336, 337. All of the magnets 331, 332, 333, 334, 335, 336, 337 have the same strength or intensity. In addition, the spacing D between each pair of adjacent magnets 331, 332, 333, 334, 335, 336, 337 is the same.

In this example, the control mechanism 306 is configured to supply pulses of power to the electromagnetic coil 305 to provide an intermittent electromagnetic retraction force RF to the elongate drive member 302 as it travels through the electromagnetic coil 305. The strength or intensity of the magnets 331, 332, 333, 334, 335, 336, 337, their spacing and the power of the pulses applied to the electromagnetic coil 305 are all selected to ensure that the elongate drive member 302 is retracted at a substantially constant speed.

The skilled person will appreciate the pulses are provided to coincide with the appropriate position of the magnets 331, 332, 333, 334, 335, 336, 337, such that that the momentum of the elongate drive member 302 causes it to continue to retract between pulses.

According to an optional feature of this example, the control mechanism 306 may include an orientation sensor (not shown), such as a gyro sensor or gyroscope. The control mechanism 306 may be configured to determine an orientation of a nailer (not shown) in which the mechanism is incorporated, and to supply pulses of power in dependence upon the determined orientation.

Referring now to FIG. 4, there is shown a retraction mechanism 401 according to a fourth example, similar to the retraction mechanism 301 according to the third example described above. Like features are depicted with like references incremented by ‘100’ relative to the retraction mechanism 301 according to the third example, and will not be described further herein.

The retraction mechanism 401 according to this example differs from that of the previous example in that the control mechanism 406 operates in a closed loop, whereby after the initial pulse of power, a detection circuit 407 initiates subsequent pulses when the position of the next magnet 431, 432, 433, 434, 435, 436, 437 is detected.

It will be appreciated by those skilled in the art that any of the retraction mechanisms 101, 201, 301, 401 described above may be used with any primary driving actuator, such as a pneumatic, explosive or even electromagnetic actuator.

It will be appreciated by those skilled in the art that several variations to the aforementioned embodiments are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1-15. (canceled)

16. A mechanism for applying a retraction force to a striking pin of a nailer, the mechanism comprising:
an elongate drive member with one or more permanent magnets;
a striking pin connected to the elongate drive member; and
an electromagnetic coil surrounding part of the elongate drive member;
wherein the electromagnetic coil is configured to be energized to apply a force to the elongate drive member to urge it toward a retracted position.

17. The mechanism of claim 16, wherein the one or more permanent magnets comprise a plurality of permanent magnets spaced along a length of the elongate drive member.

18. The mechanism of claim 17, wherein a magnetic strength of each successive permanent magnet along the elongate drive member and a spacing between each pair of adjacent permanent magnets along the elongate drive member both increase progressively toward a trailing end of the elongate drive member.

19. The mechanism of claim 18, wherein the magnetic strength of the permanent magnets and the spacing between the of adjacent permanent magnets are configured to provide a substantially constant electromagnetic retraction force to the elongate drive member as the elongate drive member moves from a deployed position toward the retracted position.

20. The mechanism of claim 19, wherein the spacing between each pair of adjacent permanent magnets is at least partially based upon the strength of the permanent magnets and a length of the electromagnetic coil along a longitudinal axis of the elongate drive member.

21. The mechanism of claim 17, which includes a control mechanism configured to supply power to the electromagnetic coil substantially continuously.

22. The mechanism of claim 17, wherein the magnetic strength of and spacing between each pair of the adjacent permanent magnets is substantially the same.

23. The mechanism of claim 17, which includes a control mechanism configured to supply pulses of power to the electromagnetic coil.

24. The mechanism of claim 23, which includes an orientation sensor operatively connected to the control mechanism to determine an orientation of the nailer in which the mechanism is incorporated, wherein the control mechanism is configured to supply pulses of power at least partially based on the orientation of the nailer determined using the orientation sensor.

25. The mechanism of claim 17, wherein the permanent magnets include an initiator magnet at or toward a leading end of the elongate drive member and opposite a trailing end of the elongate drive member, and wherein the initiator magnet has an opposite polarity to all of the other permanent magnets.

26. The mechanism of claim 17, which is operable to energize the electromagnetic coil to move the elongate drive member from a deployed position to the retracted position.

27. The mechanism of claim 17, which is operable to energize the electromagnetic coil to brake or dampen a striking movement of the striking pin.

28. A method of applying a retraction force to a striking pin of a nailer, the method comprising;
causing the striking pin of the nailer to move to a deployed position; and
energizing an electromagnetic coil to apply a force to an elongate drive member of the nailer that includes one or more permanent magnets, thereby urging the striking pin connected to the elongate drive member toward a retracted position.

29. The method of claim 28, which includes energizing the electromagnetic coil to brake or dampen a striking movement of the striking pin.
